(19) United States
(12) Patent Application Publication
(10) Pub. No.: US 2016/0328921 A1
(43) Pub. Date: Nov. 10, 2016

(54) TOURNAMENT GAMING PROGRAM

(71) Applicant: Tyche Ventures, LLC, Indianapolis, IN (US)

(72) Inventors: James Higdon, Jeffersontown, KY (US); Jonathan Wales, Indianapolis, IN (US)

(21) Appl. No.: 15/149,708

(22) Filed: May 9, 2016

Related U.S. Application Data
(60) Provisional application No. 62/158,692, filed on May 8, 2015.

(51) Int. Cl. G07F 17/32

(52) U.S. Cl. CPC G07F 17/3276; G07F 17/3288

(57) ABSTRACT

This invention relates generally to statistical games and assignments or selection of certain data subsets to participants. The invention assigns batches of varying probability brackets to each participant so that the overall weighted pool is of the same likelihood of winning as other participant's weighted pool.

### CROSS-REFERENCE TO RELATED APPLICATION

This U.S. Patent Application claims priority to U.S. Provisional Application No. 62/158,692 filed May 8, 2015, the disclosure of which is considered part of the disclosure of this application and is hereby incorporated by reference in its entirety.

### FIELD OF THE INVENTION

This invention relates generally to statistical games and assignments or selection of certain data subsets to participants. More particularly, this invention is directed to gaming software whereby a set of possible outcomes from a tournament or other closed-universe competitive scenario is assigned to gaming participants.

### BACKGROUND

NCAA bracket challenges have proliferated in recent years as sponsors have realized the popularity of the NCAA tournament among key demographics. As these bracket challenges enter the market, some sponsors are seeking more progressive prize and incentive structures, as well as games that keep participants engaged longer.

Recently, Warren Buffet and Berkshire Hathaway famously offered $1 billion for any individual who submits a “perfect bracket” for the NCAA tournament, i.e., submitting a predictive bracket that correctly identifies the winner of each of the 63 games in a 64-team tournament. For such a tournament, there are approximately 9.2 quintillion bracket combinations, and even accounting for historical trends (e.g., the fact that a 16 seed has never beaten a 1 seed), the odds of picking a perfect bracket are estimated to be roughly 1 in 2.4 trillion. During the 2015 NCAA tournament, there was only one perfect bracket after the first 32 games, which was subsequently broken during the set of the following 16 games. Despite these tall odds, the Buffet bracket challenge was highly successful in securing participant data and for use as a marketing opportunity. And while participants enjoyed the thought of being the person to submit the perfect bracket, the interest waned—in part—because there was no guarantee of a winner.

While the odds are astronomical, there remains a finite number of outcomes or bracket possibilities. There remains a desire and need in the marketplace to develop a software platform that can take the number of potential outcomes from such a large pool of eventualities, divide them between the number of participants in the game, and assign each participant a large “batch” of potential outcomes from which at least one winner must emerge. For example, there are 9,223,372,036,854,775,808 NCAA bracket iterations. With 10 million players, each participant would start the NCAA tourney with 922,337,203,685 viable brackets. There is also desire for such software in a variety of similar settings, such as World Cup soccer, Olympic events, or other similar tournament style games.

### BRIEF SUMMARY OF THE INVENTION

In one aspect, this disclosure is related to a method for playing a game wherein participants have a set of potential outcomes from a series of events associated with an individual participant's entry. The method includes: Identifying the total number of permutations of potential outcomes of the series of events; Assigning a probability to each permutation of that particular permutation resulting in each event in the series having a given outcome, wherein said assignment of probability is based on weighted criteria; Entering each participant into the game; Relating each permutation to a given participant; Eliminating each permutation that is incorrect at the conclusion of each event in the series; Identifying a winning permutation that correctly identifies each event in the series that is associated with a given participant.

Optionally, the series of events may be a single-elimination tournament wherein the series of events comprises at least 63 games.

Optionally, the probability of each permutation may be assigned based partly on historical data, weighted strength of schedule outcome, at least one professional analyst's predictions, or on at least all three pieces of input.

In another aspect, the method may include creating a balanced pool of permutations, wherein the pool of permutations for one participant has substantially the same odds of having the winning permutation as that of a pool of permutations for a second participant.

In another aspect, the method may include random assignment of the pool of permutations to participants without any participant input, ordered assignment of the pool of permutations to participants taking into consideration of participant input regarding at least one outcome of an event in the series of events, or by taking into consideration participant input regarding at least one complete permutation.

In another aspect, each permutation is ranked permutation and assigning a value to each permutation based on the statistical probability of that particular permutation being the winning permutation. Moreover, each permutation may be pooled with other permutations, after which each participant may select a pool of permutations according to their value.

In another aspect, the method may display the total number of permutations available, the number of permutations already related to participants, and the total number of participants.

In yet another aspect, the method may include using a probability threshold that reflects the likelihood of that particular permutation to be the winning permutation, such that participants are informed of how many permutations are available or remain that are above the probability threshold. The probability threshold may be based in part on historical data, weighted strength of schedule outcome, at least one professional analyst's predictions, or on at least all three factors.

In yet another aspect, the method may include comprising predictively displaying the number of permutations remaining when a certain event outcome is considered before the event begins.

In another embodiment, the invention is a method for playing a game wherein participants have a set of potential outcomes from a series of events associated with an individual participant's entry. In this way, the method comprises identifying the total number of permutations of potential outcomes of the series of events in a single-elimination tournament having at least 63 games; assigning a probability to each permutation of that particular permutation resulting in each event in the series having a given outcome, wherein said assignment of probability is based on weighted criteria including historical data, weighted strength of schedule outcome, and at least one professional analyst's predictions; entering each participant into the game by collecting input from the participant related to at least one given event within the series; relating each permutation to a first participant to create a balanced pool of permutations, wherein the pool of permutations for the first participant has substantially the same odds of having the winning permutation as that of a pool of permutations for a second participant; eliminating each permutation that is incorrect at the conclusion of each event in the series; displaying the total number of permutations available, the number of permutations already related to participants, and the total number of participants; identifying a winning permutation that correctly identifies each event in the series that is associated with a given participant.

In yet another aspect, the steps of the invention may be performed by a computer and communicated to a participant's mobile device.

While the description herein contains great specificity, this should not be construed as limitations on the scope of any embodiment, but as exemplifications of various embodiments thereof. Many other ramifications and variations are possible within the teachings of the various embodiments. Other features and advantages of the present invention will become apparent from the following detailed description of the invention.

### DETAILED DESCRIPTION OF THE INVENTION

The following description includes discussion given by way of example of implementations of embodiments of the invention. The discussions should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

The invention disclosed herein provides an algorithm and software program for use on, e.g., a mobile application platform that assigns a broad range of potential outcomes to each gaming participant. While the example of the NCAA basketball tournament bracket is used herein as an example, such reference should be understood to be illustrative—and not restrictive—in nature. The program is designed to analyze each of the myriad possibilities and track the participants' diminishing potentially winning outcomes until the tournament is complete. At that point, the participant with the winning outcome may be assigned a prize.

In the program of this disclosure, a winning entry from a participant is guaranteed by “pooling” the entire universe of possibilities and dividing them among all participants using an algorithm designed to evaluate the likelihood of a winning outcome from one bracket selection and aggregate other selections in order to provide and overall pool that is tailored to the particular participant's preferences. That is, if a participant desires a more evenly balanced pool, the pool will include a weighted allocation of outcomes with very low, moderate, and very high likelihoods of success. Alternatively, if a participant wanted pools with multiple variations of the games, but a particular outcome (e.g., University of Louisville versus Kansas State University in the final Championship game), the program would assign those iterations to said participant.

### Functionality and Program Features

In the primary aspect, the program is designed such that at the conclusion of the tournament, a single participant will possess a perfect bracket, and they will be awarded the grand prize. Upon entry, participants may complete a bracket using traditional methods, enter certain preferences, or opt for a completely random assignment. The program then “builds” a bracket portfolio or pool around the participant's core bracket, yielding numerous viable brackets for the participant ranging from the statistically improbable to the highly likely to begin the tournament. The result of each game in the tournament will reduce the amount of the participant's remaining viable, perfect brackets, eventually yielding a singular winner.

The current invention's design is exactly opposite to prior art approaches. That is, current bracket competitions are “additive” in nature, where participants attempt to select a rational winning bracket, and the cumulative scores produce a winner. The program of the current invention is a “subtractive” game in that the entire universe of possible outcomes (i.e., 9.2 quintillion brackets for the NCAA tournament) is defined and then divided among all participants. That pooling ensures a singular winner. The program requires the storage and processing of quintillions of data points and potential outcomes. Additionally, the program encourages participant input by allowing them to fill out their preferred core bracket, and then building their bracket portfolio on it based on set tolerances. Each participant is afforded the same opportunity to win based on their bracket portfolio having the same statistical likelihood of containing the perfect bracket.

In another aspect, the program is designed to provide real time feedback to each individual participant related to their remaining brackets and the statistical probability of one of the remaining outcomes ultimately being successful.

### Bracket Assignments:

The program is designed to rapidly analyze any participant input and compare said input against the statistical plot of possible outcomes and their likelihood. The program then adaptively selects a pool of possible outcomes to pair with the participant input in order to facilitate a fair and equitable competition. While calculations vary, some estimates indicate that if there are 10,000,000 players, a single participant may have as many as 240,000 brackets with a statistically significant chance of winning.

### Options for Assignments:

Option 1 (random assignment): participant is assigned a balanced batch of brackets upon entering the contest.

Option 2a (Pick-a-bracket): participant is allowed to manually fill out one or multiple brackets. This gives the contestant more of a customized, rooting interest in the process as they follow their favorite team or ideal bracket. The balance of the pooled brackets are then selected from statistically diverse options to create an overall balanced pool to ensure similar odds of winning as other participants.

Option 2b (pick-a-round): participants select winners of particular rounds, and have the system generate brackets built around these selections. For example, one participant my select University of Louisville as the overall champion, but let the program select all other winners of games. Again, the balance of the games within the selected entry, as well as the balance of the pooled brackets, are selected to ensure an overall balanced pool of similar odds to all other participants.

Option 3 (batch rating): rather than an equally balanced bracket distribution, the program may be designed to use some third party ranking or analysis to rate each permutation. That is, by using, e.g., historical data, Las Vegas odds, Nate Silver's FiveThirtyEight analyses, or some other differentiator, individual or batches of will be “rated” using a Junk-AAA system similar to those used in equities. Participants would then have the option to bid or pay additional fees for higher-rated permutations or batches.

Additional options/celebrity interfacing: in yet another optional aspect, the program may include interacting with myriad ex-players, celebrities or sports writer or commentator's bracket. Players may be able to select from a list of brackets pre-filled by celebrities, or “pair” with a celebrity in the latter rounds of the tournament when winning bracket iterations are reduced to a lower level.

### Elements of Display

Display of the massive amount of data being processed by the program is key to usability and retention or attraction of participants. A few optional elements are noted below, although this list is given by way of illustration only, and is not in any way limiting.

Displaying raw number of brackets upon entry. In this optional aspect, the program may display the total number of brackets available, the total taken, and the total number of participants in the game.

Viable brackets remaining. In another optional aspect, the program may display how many “viable” brackets remain unassigned, based on a probability threshold that the participant or the program may select. Further, later in the tournament, the program may also reveal how many viable brackets remain in the game.

The number of brackets a participant has left alive based on outcomes of individual games. The program may also optionally display the number of brackets that a participant has remaining after each game and round. Also, the program may predictively set out how many brackets will remain after given results from games if the participant selects how the game may end.

A view of each individual bracket. Further, the program may optionally allow the participant to view each individual bracket from their own assigned pool, and also may allow the participant to view the bracket of any other participant they may select.

### Additional Functionality

In another optional aspect, the program may allow a participant to use a bracket manager, whereby the participant is enabled to track particular features of all of the participant's brackets, including items like the number of brackets with a particular winner of a given game selected.

In yet another optional aspect, the program may include links to the different team schedules, statistics, and message boards.

In yet another optional aspect, the program may include a bracket uploader, which is designed to allowing participants to take a picture of a paper bracket(s), then upload said bracket into the bracket manager and automatically populate a bracket per the selected outcomes from the written bracket.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method for playing a game wherein participants have a set of potential outcomes from a series of events associated with an individual participant's entry, the method comprising:
a. Identifying the total number of permutations of potential outcomes of the series of events;
b. Assigning a probability to each permutation of that particular permutation resulting in each event in the series having a given outcome, wherein said assignment of probability is based on weighted criteria;
c. Entering each participant into the game;
d. Relating each permutation to a given participant;
e. Eliminating each permutation that is incorrect at the conclusion of each event in the series;
f. Identifying a winning permutation that correctly identifies each event in the series that is associated with a given participant.

2. The method of claim 1, wherein the series of events is a single-elimination tournament.

3. The method of claim 1, wherein the series of events comprises 63 games.

4. The method of claim 1, wherein the probability of each permutation is assigned based partly on historical data.

5. The method of claim 1, wherein the probability of each permutation is assigned based partly on weighted strength of schedule outcome.

6. The method of claim 1, wherein the probability of each permutation is assigned based partly on at least one professional analyst's predictions.

7. The method of claim 1, wherein entry of a participant comprises collecting input from the participant related to their preferred permutation of the entire series of events.

8. The method of claim 7, wherein relating each permutation to a participant includes creating a balanced pool of permutations, wherein the pool of permutations for one participant has substantially the same odds of having the winning permutation as that of a pool of permutations for a second participant.

9. The method of claim 1, wherein entry of a participant comprises collecting input from the participant related to at least one outcome of an event in the series of events.

10. The method of claim 9, wherein relating each permutation to a participant includes creating a balanced pool of permutations, wherein the pool of permutations for one participant has substantially the same odds of having the winning permutation as that of a pool of permutations for a second participant.

11. The method of claim 1, wherein relating each permutation to a participant includes creating a balanced pool of permutations, wherein the pool of permutations for one participant has substantially the same odds of having the winning permutation as that of a pool of permutations for a second participant.

12. The method of claim 7, wherein relating each permutation to a participant includes ranking each permutation and assigning a value to each permutation.

13. The method of claim 12, further comprising selection by each participant of a pool of permutations according to their value.

14. The method of claim 1, further comprising displaying the total number of permutations available, the number of permutations already related to participants, and the total number of participants.

15. The method of claim 1 further comprising using a probability threshold, such that participants are informed of how many permutations are available or remain that are above the probability threshold.

16. The method of claim 1 further comprising predictively displaying the number of permutations remaining when a certain event outcome is considered before the event begins.

17. A method for playing a game wherein participants have a set of potential outcomes from a series of events associated with an individual participant's entry, the method comprising:
a. Identifying the total number of permutations of potential outcomes of the series of events in a single-elimination tournament having at least 63 games;
b. Assigning a probability to each permutation of that particular permutation resulting in each event in the series having a given outcome, wherein said assignment of probability is based on weighted criteria including historical data, weighted strength of schedule outcome, and at least one professional analyst's predictions;
c. Entering each participant into the game by collecting input from the participant related to at least one given event within the series;
d. Relating each permutation to a first participant to create a balanced pool of permutations, wherein the pool of permutations for the first participant has substantially the same odds of having the winning permutation as that of a pool of permutations for a second participant;
e. Eliminating each permutation that is incorrect at the conclusion of each event in the series;
f. displaying the total number of permutations available, the number of permutations already related to participants, and the total number of participants;
g. Identifying a winning permutation that correctly identifies each event in the series that is associated with a given participant.

18. The method of claim 17 further comprising ranking each permutation by assigning a value to each permutation related to each permutation's overall probability of being the winning permutation.

19. The method of claim 17 further comprising using a probability threshold, such that participants are informed of how many permutations are available or remain that are above the probability threshold.

20. A method for playing a game wherein participants have a set of potential outcomes from a series of events associated with an individual participant's entry, the method comprising:
a. Identifying the total number of permutations of potential outcomes of the series of events;
b. Assigning a probability to each permutation of that particular permutation resulting in each event in the series having a given outcome, wherein said assignment of probability is based on weighted criteria;
c. Entering each participant into the game;
d. Relating each permutation to a given participant;
e. Eliminating each permutation that is incorrect at the conclusion of each event in the series;
f. Identifying a winning permutation that correctly identifies each event in the series that is associated with a given participant;
Wherein said steps of the method are performed by a computer and communicated to a participant's mobile device.
